(19) United States
(12) Patent Application Publication
(10) Pub. No.: US 2009/0160636 A1
(43) Pub. Date: Jun. 25, 2009

(54) Intruder Detection Systems for Access Hatches

(76) Inventor: Edward Klinger, Stanmore (GB)

Correspondence Address: HATCHGUARD, INC., 5540 CONNECTICUT AVE. NW, SUITE 220, WASHINGTON, DC, 20015, US

(21) Appl. No.: 11/962,244

(22) Filed: Dec. 21, 2007

(51) Int. Cl. H04Q 7/00; G08B 13/00; G08B 1/08

(52) U.S. Cl. 340/539.1; 340/541

(57) ABSTRACT

A wireless alarm system comprising a master unit 6 and multiple slave units 4 that uses the hatch itself as a radio frequency transmission medium for communication and is able to detect and verify attacks on the hatch by forced opening, drilling, cutting, grinding and introduction of liquid contaminant.

This invention relates to a wireless alarm system that can detect and verify an illegal attempt to open or breach an access hatch that provides protection for an asset.

Companies operating in the water, gas, electricity and other utility industries need to protect their assets to ensure the safety of customers and provide uninterrupted supply of commodity. The threat of vandalism, terrorism or extortion means that points of access are vulnerable to attack. These include inspection and access hatches that may be remote and outside secure premises. Rapid response to any attack is required to limit any damage to assets, people or the environment. This will entail an alarm condition triggering a police response, which is governed by restrictions imposed in the UK by the ACPO (Association of Chief of Police Officers). Any alarm that has the potential to initiate police response must be verified before action is taken. Increasingly, companies are looking for low cost, easily maintainable solutions to address this issue.

This invention offers a detection system that is low cost, simple to install and verifies an alarm condition that could signify an attack on a hatch.

The main problem associated with installation of detection systems of this type is that long runs of expensive cabling is required to link hatches to a central monitoring point so that an alarm signal may be transmitted to a control centre. The cost of the cabling and installation is very high. Because each hatch requires a unit (slave) containing a set of sensors located within the hatch, traditional wireless systems have difficulty penetrating the hatch's metallic construction, resulting in reduced operating range and reliability. This invention uses an antenna design that attaches to the wall of the hatch by a strong magnet and electro magnetically couples radio frequencies through the hatch to the atmosphere.

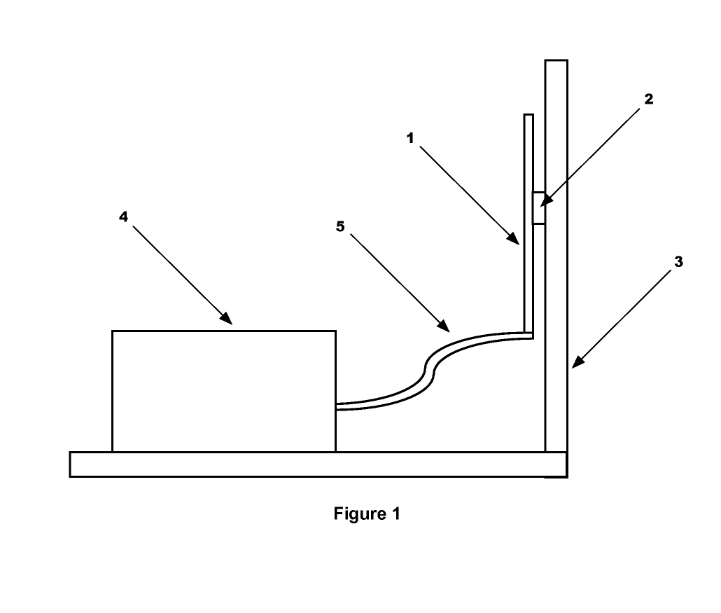

FIG. 1 (Antenna, magnet, slave and cable in hatch) shows an antenna 1 attached to the inside wall of a hatch 3 via a strong magnet 2. The antenna is connected to the slave unit 4, housed within the hatch by cable 5.

The slave unit contains a radio frequency transceiver unit that operates in the license-free ISM (Industrial, Scientific & Medical) bands within the restrictions of the regulatory document CEPT/ERC/70-03. This communicates with a master unit situated in another hatch or control hut.

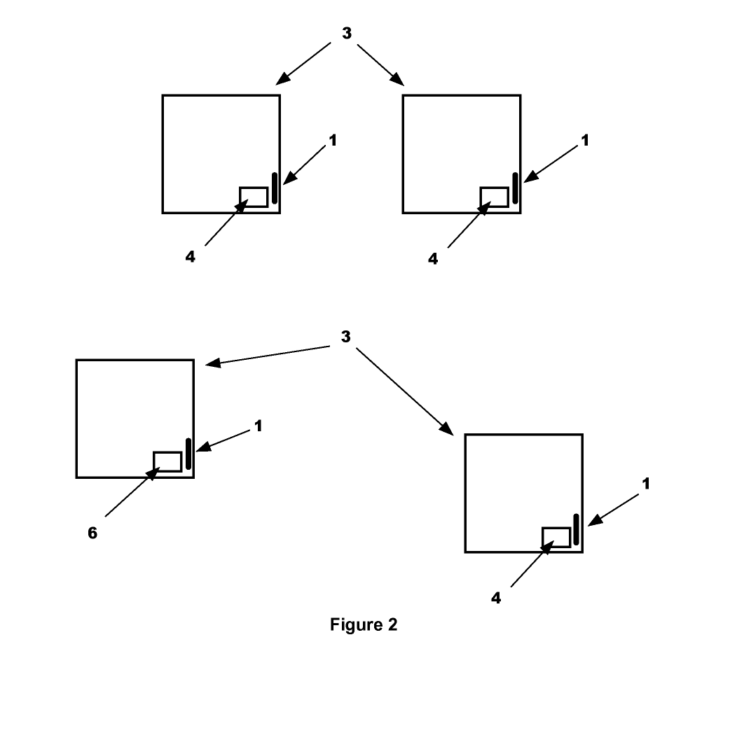

FIG. 2 (Overall detection system configuration) shows the overall detection system configuration. Multiple slave units 4 within hatches 3 communicate wirelessly with a master unit 6 via antennas 1.

Each slave and master unit contains sensors capable of detecting attack by:
1) Forced opening of the hatch cover
2) Drilling, cutting or grinding of the hatch cover
3) Hammering on the hatch cover
4) Introduction of liquid contaminant

These sensors use a dual-technology approach to verify that an actual attack is taking place rather than a random disturbance or accidental trigger event. Specifically, this invention uses a variable hardware and software algorithm to verify attack by portable hand tools such as drills, angle grinders and thermal cutting devices. The mechanical strength of hatches reduce the speed at which a successful attack may take place, therefore it may take 30 seconds or more to breach a hatch successfully. This invention monitors audio and vibration disturbances over an adjustable timeline to determine whether a real attack is in progress. If two thresholds are crossed, an alarm is communicated necessitating police response.

FIG. 3 (Waveform of a single sound burst 7) shows a waveform of a single sound burst 7 on an axis of amplitude in dB against time in seconds. It crosses the first amplitude threshold a of the audio monitor within the slave or master unit, but not the second amplitude/time threshold b. No alarm is generated.

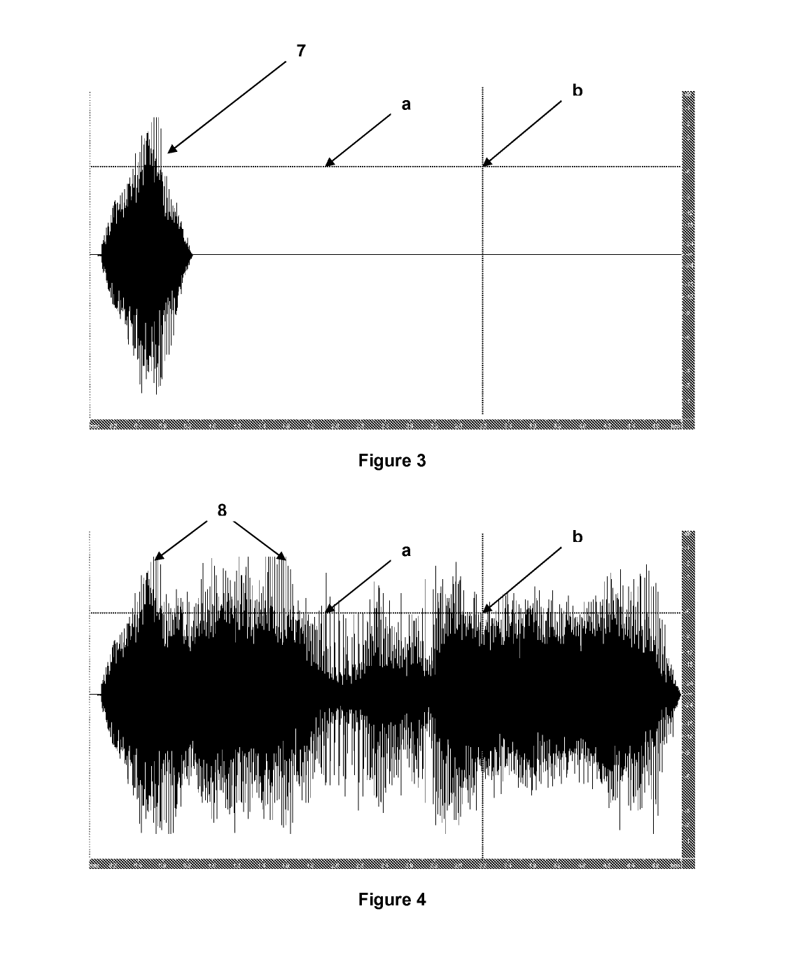

FIG. 4 (Waveform of several sound bursts 8) shows a waveform of several sound bursts 8 on an axis of amplitude in dB against time in seconds. They cross both the first amplitude threshold a and second amplitude/time threshold b of the audio monitor within the slave or master unit, triggering an alarm.

Audio is monitored using a microphone in combination with an electronic timer. When audio is detected above the adjustable level a, the timer is started. A time window is created (finishing at variable point b) whereby if the threshold is additionally crossed a set number of times, a flag generates the trigger for an alarm to be communicated by the system.

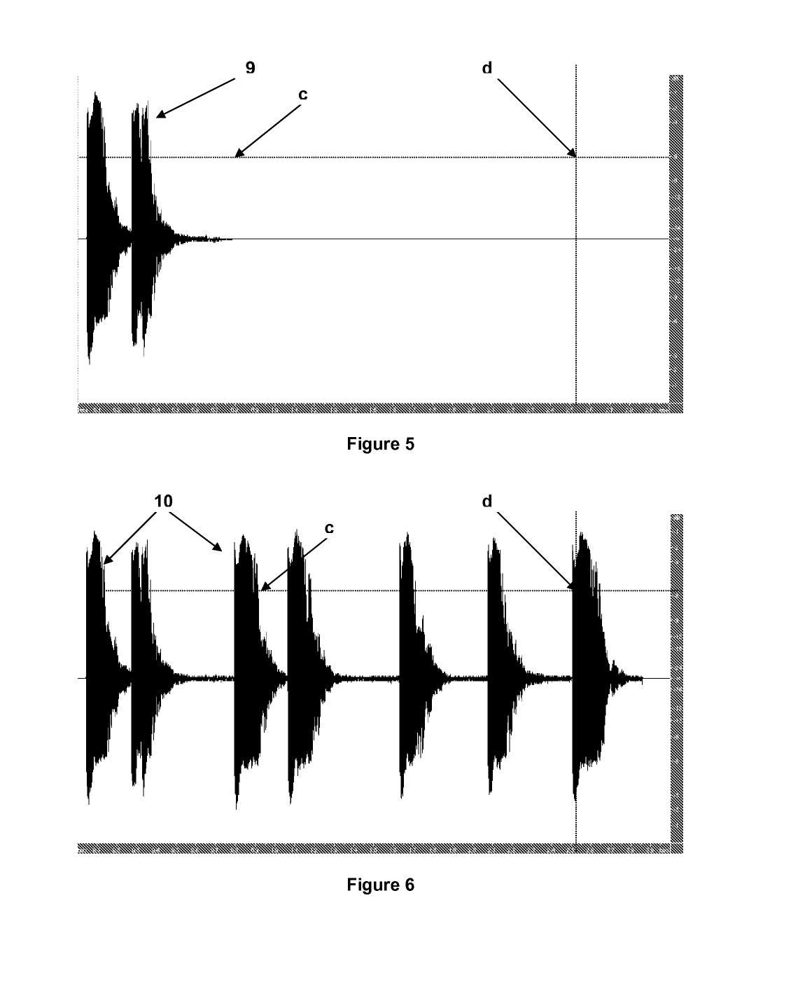

FIG. 5 (Waveform of a single vibration 9) shows a waveform of a single vibration 9 on an axis of amplitude in dB against time in seconds. It crosses the first amplitude threshold c of the vibration monitor within the slave or master unit, but not the second amplitude/time threshold d. No alarm is generated.

FIG. 6 (Waveform of several vibrations 10) shows a waveform of several vibrations 10 on an axis of amplitude in dB against time in seconds. They cross both the first amplitude threshold c and second amplitude/time threshold d of the vibration monitor within the slave or master unit, triggering an alarm.

Vibration is monitored using a tilt mechanism in combination with an electronic timer. When vibration is detected above the adjustable level c, the timer is started. A time window is created (finishing at variable point d) whereby if the threshold is additionally crossed a set number of times, a flag generates the trigger for an alarm to be communicated by the system.

| FIG. | Description |
|---|---|
| 1 | Antenna, magnet, slave and cable in hatch |
| 2 | Overall detection system configuration |
| 3 | Waveform of a single sound burst 7 |
| 4 | Waveform of several sound bursts 8 |
| 5 | Waveform of a single vibration 9 |
| 6 | Waveform of several vibrations 10 |

1. An intruder detection system for access hatches comprising a communications antenna design that electro magnetically couples radio frequency power to a metal hatch via a strong magnet.

2. An intruder detection system for access hatches according to claim 1, in which a hardware and software audio sensing algorithm is used to verify attack by drilling, cutting or grinding of a hatch frame or cover.

3. An intruder detection system for access hatches according to claim 1, in which a hardware and software vibration sensing algorithm is used to verify attack by hammering on a hatch frame or cover.
